(19) United States
(12) Patent Application Publication
(10) Pub. No.: US 2008/0215213 A1
(43) Pub. Date: Sep. 4, 2008

(54) Method and Device For Determining the Synchronous Force When Shifting a Twin Clutch Transmission of a Motor Vehicle

(75) Inventor: Markus Klump, Buehlertal (DE)

Correspondence Address: Davidson, Davidson & Kappel, LLC, 485 7th Avenue, 14th Floor, New York, NY, 10018, US

(73) Assignee: Luk Lamellen und Kupplungsbau Beteiligungs, Buehl (DE)

(21) Appl. No.: 11/795,075

(22) PCT Filed: Dec. 14, 2005
(86) PCT No.: PCT/DE05/02250

§ 371 Date: Jul. 11, 2007

(30) Foreign Application Priority Data
Jan. 13, 2005 (DE) 10 2005 001 572.7

(51) Int. Cl. B60K 23/00; G06F 19/00

(52) U.S. Cl. 701/51

(57) ABSTRACT

A method for determining the synchronous force when shifting a twin clutch transmission of a motor vehicle includes the following steps: preparing a situation table that defines typical shifting situations based on currently active gears, and of at least one operating parameter of the motor vehicle, preparing an assignment table that assigns pre-determined synchronous forces to typical shifting situations, detecting an intention to shift, determining the typical shifting situation corresponding to the respective intention to shift, and establishing the synchronous force, which corresponds to the determined typical shifting situation from the assignment table.

The invention relates to a method and a device for determining the synchronous force when shifting a twin clutch transmission of a motor vehicle.

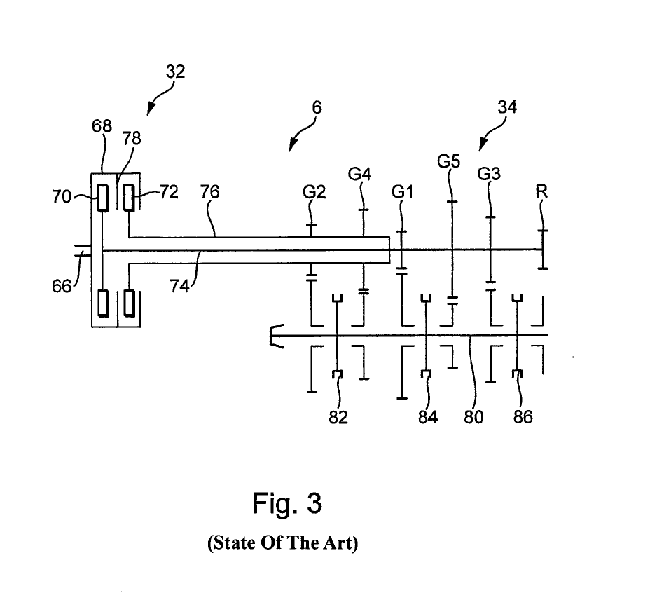

Twin clutch transmissions, which are also called parallel transmissions are being used increasingly in motor vehicles with automated drive trains, due to their good efficiency. FIG. 3 shows such a drive train schematically:

A combustion engine 4 is connected to a twin clutch transmission, designated as 6 in its entirety, with a cardan shaft 8, which drives the rear wheels 12 of a motor vehicle through a differential 10 in the shown embodiment. It is appreciated that the drive train could also be in a front wheel drive or all wheel drive vehicle.

The combustion engine 4 has a power actuating element 14, which is operated by an actuator 16. The actuator 16 is being controlled by an engine controller 20, whose inputs are supplied with the outputs of sensors, as e.g. a sensor 22 for detecting the rotation speed of the crankshaft of the combustion engine, a sensor 24 for detecting the temperature of the combustion engine, a sensor 26 for detecting the temperature and the flow rate of the fresh air supplied to the combustion engine, etc. Furthermore, the engine controller 20 is provided with the position of the load actuating element 14, and with the position of a drive pedal 30 through a position sensor 28.

The twin clutch transmission 6 is comprised of a twin clutch 32, and a transmission unit 34, which includes the gear sets. The two clutches 36 and 38 of the twin clutch transmission 32 are operated through the clutch levers 40 and 42, which are moved by the actuators 44 and 46.

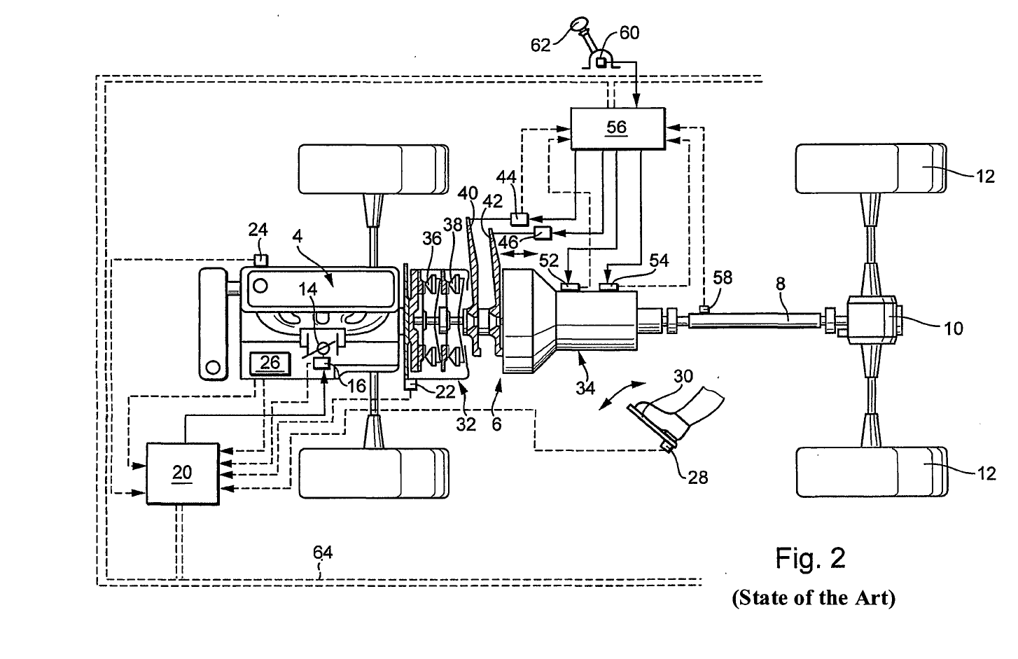

The shift elements of the transmission unit 34, which are not shown in FIG. 2, are being moved by actuators 52 and 54.

For controlling the twin clutch transmission, a transmission controller 56 is provided, whose outputs are connected to the actuators 44, 46, 52, 54, and its inputs are connected with position sensors for detecting the position of the actuators or the respective operating elements, a sensor 58 for detecting the output speed of the transmission, and a sensor 60 for detecting the position of a transmission selector lever 62, through which several programs stored in the transmission controller can be activated.

The two controllers 20 and 56, which can be connected with additional sensors, e.g. a brake pedal operation sensor, wheel rotation speed sensors, etc., communicate amongst each other via a BUS conductor 64. The functions of the controllers can be divided up in a different manner.

FIG. 3 shows the schematic layout of a twin clutch transmission, as it is known e.g. from DE 35 48454 A1.

The crank shaft 66 of the combustion engine 4 (FIG. 2) is connected torque proof with a clutch housing 68, in which two clutch disks 70 and 72 are supported coaxial and rotatable relative to each other. The clutch disk 70, which belongs to a first clutch 36 (FIG. 2), is connected torque proof with a first transmission input shaft 74, which is rotatable within a second input shaft 76, which is provided as a hollow shaft, which in turn is connected torque proof with the second clutch disk 72. The clutch disk 70 can be pressed against a face of the clutch housing 68 through a press disk, which can be operated by the clutch lever 40 (FIG. 2). The clutch disk 72 can be pressed against an annular flange 78 of the clutch housing 68 through the clutch lever 42.

The gears G2, G4 are connected with the second input shaft 76 torque proof. The gears G1, G5, G3 and R are connected with the first input shaft 74 torque proof.

Loose gears, located on the said output shaft 80 of the transmission, are assigned to said fixed gears, with the loose gears being connectable torque proof with the output shaft 80 via shift elements 82, 84, 86, each containing synchronous clutches, so that a respective gear given by the designation of the fixed gears can be shifted.

With the first clutch 36 locked (input shaft 74 connected with the crankshaft torque proof), the vehicle can be operated in first, third, fifth or reverse gear, with the second clutch closed in second or fourth gear. While the vehicle is being operated e.g. in third gear, the gears 2 or 4 can already be shifted, so that a change from third gear into second or fourth can be performed load free, only through opening the first clutch and locking the second clutch.

Each of the input shafts thus forms a partial transmission together with the assigned clutch and gear sets, wherein one partial transmission is active respectively and the other one is on “standby” during driving.

The entire configuration described so far is state of the art and will therefore not be described. It is appreciated that the twin clutch transmission, shown in FIG. 3 as three shaft transmission, can also be a four shaft transmission, which has two output shafts in the gear box, on which different gear sets are located, which are connected torque proof with an output shaft on the output side. The number of actuators depends on the respective transmission design. Not all the loose gears have to be located on the output shaft. They can also be located on the input shafts, wherein the respective gears of the output shafts are preferably connected torque proof.

Assuming e.g. that the vehicle drives in second gear, this means the clutch associated with the clutch disk 72 is closed, and the gear of the output shaft 80, assigned to the gear G2, is connected torque proof with the output shaft 80 via the shift element 82. In this state one of the gears 1, 3 or even 5 can be shifted or pre selected through respective operation of one of the shift elements 84 or 86, wherein during shifting or synchronization the rotation speed of the input shaft 74 is changed according to the transmission ratio given by the respective gear ratio.

During a respective rotation speed change of the input shaft not coupled with the combustion engine, the associated inert masses have to be accelerated or braked, which becomes noticeable through a deceleration or acceleration of the vehicle in a comfort degrading manner.

For good shifting comfort, on the one hand, and sufficiently short shifting times, when required, on the other hand, therefore, a determination of the synchronous forces is required, through which the respective shift elements are being operated when shifting a gear, wherein the accomplished shift times depend on the synchronous forces and the required rotation speed changes of the shifted shaft.

The object of the invention is to determine the synchronous forces, so that a good compromise between shift comfort and shift time is accomplished with limited application- or computation effort, the transmission is not loaded excessively through unnecessarily high synchronous forces, or the actuators consume an unnecessarily high amount of energy or power.

This object is accomplished through a method for determining the synchronous force when shifting a double clutch transmission of a motor vehicle, which includes the following steps:

preparing a situation table that defines typical shifting situations based on currently active gears, currently shifted gears of the inactive shaft, target gears, and at least one operating parameter of the motor vehicle; preparing an assignment table that assigns pre determined synchronous forces to typical shifting situations,

detecting an intention to shift,

determining the typical shifting situation, corresponding to the respective intention to shift, and determining the synchronous force, which corresponds to the determined typical shifting situation from the assignment table.

Surprisingly, it has become evident that the shifts occurring in practical operation can be categorized into few typical shifting situations, to which predetermined synchronous forces can be assigned. During driving operation, the vehicle- and transmission situations, e.g. vehicle speed, position of drive- and brake pedal, gear, in which the vehicle is presently driven, target gear after the next shifting, etc., are being processed according to a program, stored in the transmission controller and assigned to a predetermined shifting situation. This way it is possible, on the one hand, to greatly reduce the application effort to balance the shifting operations, and, on the other hand, to reduce the computation effort and to reach synchronization times according to requirements. In critical situations, which require rapid shifting, shifting is performed with high synchronous force if necessary. However, during other shifting operations, shifting is performed with lower synchronous forces with lower loading of the transmission and with high shifting comfort.

Preferably, the position of the drive pedal is the at least one operating parameter, which is considered during determination of the typical shift situation.

In most cases, it is sufficient to define the following typical shift situations according to the invention:

“fast gear shift”

“coast shifting”

“normal upshift”, and

normal downshift”

The shift situation “fast gear shift” is, e.g. defined for shifts, in which the target gear is not shifted yet, when a wish to shift exists, and the motor vehicle is not in a coast state.

The synchronous force read out of the assignment table can be modified, depending on an operating parameter of the motor vehicle.

A device for determining the synchronous force, when shifting a twin clutch transmission of a motor vehicle, preferably includes:

sensors for determining the values of operating parameters of the motor vehicle,

an electronic control device, which controls clutch actuators and shift actuators of the twin clutch transmission depending on the values of the operating parameters, wherein in a storage device of the control device, a situation table, which defines typical shift situations according to gears presently active, presently shifted gears of the non active shaft, target gears, and at least one operating parameter of the motor vehicle, and an assignment table are stored, which assigns predetermined synchronous forces to typical shift situations, and the control device controls the shift actuators according to one of the said methods.

The invention is subsequently described with reference to schematic drawings in an exemplary manner and with further details.

The figures show in:

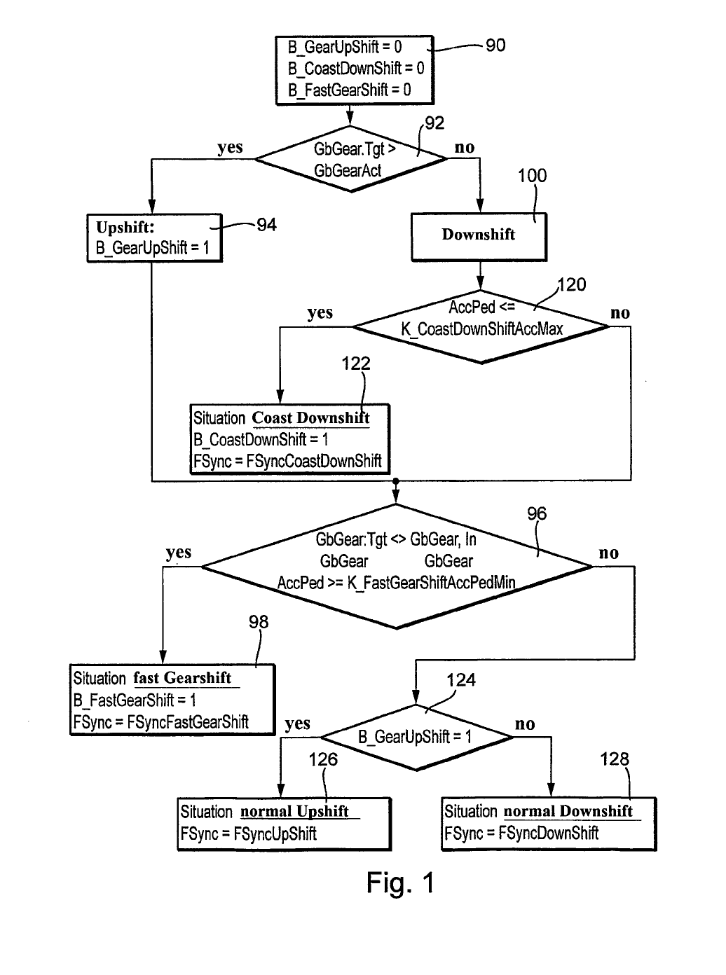

FIG. 1 a flow chart for illustrating an embodiment of the method according to the invention.

FIG. 2 a basically known drive train of a motor vehicle, and

FIG. 3 the configuration of a known twin clutch transmission.

Subsequently, an example of the method according to the invention for determining the synchronous force when shifting a twin clutch transmission, is described with reference to FIG. 1, wherein the method is performed in a drive train of a motor vehicle according to FIG. 2.

It is assumed that the transmission controller 56 in step 90 of FIG. 1 is in a state, in which no wish to shift exists, this means the vehicle drives in a gear determined by the program stored by the transmission controller 56, and the respective operating parameters like position of drive pedal, rotation speed of the combustion engine, and rotation speed of the cardan drive shaft. A bit corresponding to a desire to upshift (B_GearUpShift), thereby equals zero. A bit corresponding to a coast shift (B_CoastDownShift), and a bit corresponding to a fast gear shift (B_FastGearShift), also equal zero.

It is being assumed now, that the system detects a desire to shift, e.g. through direct operation of the gear selector lever 62, through increasing or decreasing operation of the drive pedal 30, etc. The program then transitions to the step 92, in which it is being checked, if a target gear GbGear.Tgt identified by the program, which is to be shifted anew, is higher than the currently shifted gear GbGearAct. Engaged gear means the gear with whose gear ratio the vehicle is being driven, this means whose clutch is locked. A shifted gear is subsequently understood as a gear, which is already shifted after synchronization, but whose assigned input shaft is not coupled to the crankshaft.

If the condition checked in step 92 applies, it is an upshift (step 94) and a bit B_GearUpShift is set to 1.

The program then moves to step 96, in which it is being determined if the requested target gear GbGear.Tgt is not equal to the gear shifted on the non coupled shaft, and thus the pre selected gear GbGear.In. Furthermore, it is being tested, if the operation AccPed of the drive pedal is above a threshold value K_FastGearShiftAccPedMin, which corresponds to a strong wish to accelerate. When the conditions of step 96 are fulfilled, this is being identified as a shift situation “fast gear shift” required, and a corresponding Bit B_FastGearShift is set to 1. To this shift situation a synchronous force FSync=FSyncFastGearShift is assigned, which is sufficiently large, so that an immediate fast synchronization is performed, which allows a rapid gear shift (step 98).

When it is determined in program step 92, that the target gear GbGear.Tgt is not higher than the currently engaged gear, this condition is recognized in step 100 as a condition for downshifting.

In step 120, it is then being checked, if the operation of the drive pedal is smaller than a threshold value K_CoastDownShiftAccMax. Under such a condition of the drive pedal, a rollout condition of the vehicle is assumed, to which the shift situation “Coastshift” is assigned, in which a respective bit B_CoastDownshift is set to 1, and the synchronous force, through which a respective switching component is operated by the assigned actuator, is set to the value FSync=FSyncCoastDownShift, which is relatively small, so that a shifting of a gear is not perceived as degrading driving comfort.

When the condition of step 120 is not fulfilled, the program again proceeds to step 96.

When the conditions defined therein are not fulfilled, it is being checked in step 124, if the upshift bit B_GearUpShift is set to 1 (step 94). If this is the case, this is identified in step 126 as the shift situation “Normal Upshift”, to which the synchronous force F_Sync=FSyncUpShift is assigned as a force, corresponding to a normal, comfortable not unnecessarily fast upshift. When “no” is determined in step 124, this is identified in step 128 as shift situation “Normal Downshift”, to which the synchronous force FSync=FSyncDownShift is assigned, which leads to a comfortable transmission saving normal downshift.

The above described flowchart is only exemplary. The process according to the invention can be supplemented by additional typical shift situations.

The shift situation “Fast Shift” or shifting immediately required comprises all shifts, in which the new drive gear is not yet shifted, with the exception of the coast shifts. As discussed, the situation is determined through monitoring the drive gear and the gears shifted on both shafts. Furthermore, the state of overlap of the operation of both clutches can provide indications towards a time critical shifting, which has to be performed as quickly as possible. A kick down switch can also be included into the determination of the state, since it often initiates double downshifts. Since there are situations, in which the new required drive gear is not yet shifted, but the shifting does not have to be performed quickly with high synchronous force, coast shifting has a higher priority than the fast gear shifting; this means it is being recognized first.

As coast shifts generally downshifts are being subsumed, in which the drive pedal is only operated very little at the most, and the brake is possibly operated in addition. Such shifts degrade the drive comfort very much, when they are not well balanced, so that small synchronous forces are favorable.

Normal upshifts are not time critical, so that the synchronous force can be selected according to the criteria of maximum comfort and minimum synchronization loading.

Also normal down shifts are not time critical. However, in order to limit the time span and to load the synchronization to a lesser extent, an engine rotation speed dependent the synchronous force component can be added, which is determined according to conventional synchronization strategies, in addition to the parametric or pre determined synchronous force FSyncDownShift (step 128).

Overall, the invention allows managing with one respective synchronous force for the four typical shift situations, and possibly an additional characteristic diagram with a parameter number for the engine rotation speed dependent synchronous force component for downshifts, depending on the number of gears.

The parameters in an actual example are a synchronous force for normal upshifts of 700 N, for normal downshifts of 750 N, for immediately necessary shifts of 1,500 N, and for coast shifts of 450 N. The drive pedal operation during coast shift is below 1% of travel. The pedal operation necessary for initiating a fast gear shift is, e.g., over 40% of pedal travel.

### REFERENCE NUMERALS

4 Combustion engine
6 Twin clutch transmission
8 Cardan drive shaft
10 Differential
12 Rear wheel
14 Power actuating element
16 Actuator
18 Actuator
20 Engine controller
22 Sensor
24 Sensor
26 Sensor
28 Sensor
30 Drive pedal
32 Twin clutch
34 Transmission unit
36 Clutch
38 Clutch
40 Clutch lever
42 Clutch lever
44 Actuator
46 Actuator
48 Switching component
50 Switching component
52 Actuator
54 Actuator
56 Transmission control system
58 Sensor
60 Sensor
62 Transmission select lever
64 Bus conductor
66 Crank shaft
68 Clutch housing
70 Clutch disk
72 Clutch disk
74 Input shaft
76 Input shaft
78 Annular flange
80 Output shaft
82 Switching component
84 Switching component
86 Switching component

1-6. (canceled)

7. A method for determining a synchronous force when shifting a twin clutch transmission of a motor vehicle comprising the following steps:
providing a situation table defining typical shift situations based on presently active gears, presently shifted gears of a non active shaft, target gears, and at least one operating parameter of the motor vehicle;
providing an assignment table, the assignment table assigning predetermined synchronous forces to the typical shift situations;
detecting an intention to shift;
determining the typical shift situation corresponding to the intention to shift; and
determining the synchronous force corresponding to the determined typical shift situation from the assignment table.

8. The method as recited in claim 1 wherein the at least one operating parameter of the motor vehicle is a position of a drive pedal.

9. The method as recited in claim 1 wherein typical shift situations include:
a fast gear shift,
a coast shift,
a normal upshift, and
a normal downshift.

10. The method as recited in claim 1 further comprising identifying shifts when a target gear is not yet shifted when the intention to shift is present, and the motor vehicle is not in a coast state.

11. The method as recited in claim 1 wherein the synchronous force, read out of the assignment table, is modified depending on the operating parameter of the vehicle.

12. A device for determining the synchronous force when shifting a twin clutch transmission of a motor vehicle, including
sensors for detecting the values of the operating parameters of the motor vehicle;
a control device controlling shift actuators according to the method of claim 1; and
an electronic control device controlling clutch actuators and the shift actuators of the twin clutch transmission depending on the values of the operating parameters.
